(19) United States
(12) Patent Application Publication
(10) Pub. No.: US 2018/0341914 A1
(43) Pub. Date: Nov. 29, 2018

(54) NFC TRACKING SYSTEM

(71) Applicant: Avery Levy, Longboat Key, FL (US)

(72) Inventors: Avery Levy, Longboat Key, FL (US); John Cronin, Bonita Springs, FL (US); Michael D'Andrea, Burlington, VT (US)

(21) Appl. No.: 15/989,785

(22) Filed: May 25, 2018

Related U.S. Application Data
(60) Provisional application No. 62/511,049, filed on May 25, 2017.

(51) Int. Cl. G06Q 10/08; G06K 7/10; G06K 19/07

(52) U.S. Cl. CPC G06Q 10/0838; H04B 5/0068; G06K 19/0723; G06K 7/10297

(57) ABSTRACT

The present disclosure discloses one or more NFC tags embedded in, affixed to, or printed into a delivery label that may be used to track mail. After an NFC shipping tag has been scanned, delivery information relating to shipping a piece of mail may be received and stored in a database, where that shipping information may be associated with the scanned NFC tag. When a shipping label includes two parts, a first part may be a receipt that can be detached and retained by a sender of a piece of mail, and a second part may stays attached to that piece of mail as it is delivered to a destination. A sender preparing to send mail may provide information that allows electronic devices to receive messages as a NFC shipping label is scanned by different NFC scanners at different locations as that mail moves toward a destination.

### CROSS REFERENCE TO RELATED APPLICATIONS

This application claims priority benefit of U.S. provisional patent application 62/511,049 filed May 25, 2017, entitled NFC Tracking System, the disclosure of which is incorporated herein by reference.

### BACKGROUND OF THE INVENTION

### Field of the Invention

The present invention generally concerns delivery systems. More specifically, the present invention concerns leveraging near field communications (NFC) to track deliveries while safeguarding a parallel chain of custody with a customizable list of relevant parties.

### Description of the Related Art

Legacy or traditional mail tracking systems have significant limitations in part because they often require that at least some manually entered information. Documents that are used to send letters or packages commonly rely on manual entries, even when such documents include computer scan-able items, such as a barcode label errors or omissions made at a manual data entry phase may cause a package to be lost or delayed. For example, return receipt post cards, Express Mail multi-layer ‘carbon paper’ forms, certified mail labels, or registered mail forms each include information that must be entered by hand. In certain instances, such manual entries are too laborious or are confusing to customers of a mail delivery system. As such, a lack of attention to detail or human error can lead to package shipment information being entered incorrectly.

Another weakness associated with today's mail processing relates to the centers that transport the mail. For example, processing requirements relating to logging packages as they are processed at a facility or procedures associated with tracking certain classes of packages may not be adhered to properly by staff. Such deviations from standard practices are often based on human errors that include not scanning a barcode of a package as it is received, moved, or otherwise dispositioned can cause a package to be lost or not be properly tracked as it moves through a delivery system. One issue that can cause a package from being detected may relate to the fact that barcode scanners require a direct line-of-sight path to read that barcode. Any obstruction that blocks a line-of-sight between a scanner and a barcode can cause a barcode to be missed. As such, problems associated with a shipping entity accurately tracking packages may be limited by environmental conditions or simply by one package blocking another package, for example a box sitting on top of a letter could cause a barcode on a letter not to be scanned. In yet another example, even a barcode that is partially covered or otherwise obscured may not be read or read correctly by a barcode scanner.

On Nov. 27, 2017 the Office of Inspector General (US OIG) of the U.S. Dept. of Health and Human Services released a report that identified several weaknesses associated with certified main and the U.S. Postal Service. The weaknesses identified in this report include were separated into at least several categories that included poor customer experiences and high cost ($3.35 per piece of certified mail). Poor customer experiences are exemplified by long wait times in lines at the post office, difficulties in filling out certified mail forms correctly, and missing or unreadable signatures. It should be noted that the related provisional patent application noted in this specifications Cross Reference to Related Applications was filed on May 25, 2017 before this report was released by the US OIG, as such the US OIG report is not prior art. This OIG report suggested at least four potential enhancements that that should help the U.S. Postal Service enhance certified mail. The improvements noted in this report included digitizing the sender's receipt, taking a photo/picture of the recipient, providing automatic tracking updates to senders through a mobile phone application, and digitally transmitting information to electronic devices via a service. This report also noted that demographic groups between the ages of 18-24 and 25-34 are less likely to use certified mail as compared to other age groups.

The US OIG also released a report regarding registered mail on Jul. 14, 2017, again after the effective filing date of the aforementioned related U.S. provisional patent application. The US OIG Jul. 14, 2017 report highlighted at least six different sets of requirements, limitations, aspirations, and/or recommendations that should be considered or imposed to improve the U.S. registered mail process. First of all an accountable individual must sign for a piece of registered mail each time it changes hands, where each intermediate office that the registered mail passes through must prepare control logs that track individual pieces of registered mail. One limitation identified in the Jul. 14, 2017 report noted that 14 out of 15 post offices visited did not follow standard USPS operational controls when handling registered mail and that this caused the USPS to frequently provide inadequate and ineffective handing of registered mail because USPS controls were not correctly followed.

The OIG then recommended that the US registered mail process be improved by compelling management to verify that employees be responsible to follow USPS registered mail controls, to update manual processes using available or new technologies, and to monitor the effectiveness of improvements to the US registered mail process over time. Recommendations included a) Post offices could/should move away from manual forms for the Registered Mail process to automated documentation to eliminate duplication of entries, the use of carbon paper, and to facilitate better information sharing. b) The Postal Service could replace the manual ‘no Registered Mail articles and no remittance’ (Nil-Bill) process, possession signatures, and control logs with electronic notifications to improve efficiency. c) Global trends and competitors that could/should be examined to potentially improve technologies and strategies to simplify the Registered Mail process, capture more revenue from technology-savvy customers, and make the process more efficient. d) The use of these technologies could also minimize the risk associated with unlocked cages, cabinets, or safes. Further, these capabilities may lead to additional cost savings from fewer insurance claims.

Additionally, the current registered mail process is manual, includes hand-to-hand transfer that delays delivery of packages to a final destination. Recommended process improvements and efficiencies included electronically automating forms (such as Form 3806, Form 3854 and Form 3854A), for example via an online process/portal. Finally, the OIG registered mail report from Jul. 14, 2017 identified that opportunities exist for the US Postal Service to connect with various start-up companies to find products available to assist with updating and modernizing the registered mail process.

Similar issues and limitations are experienced by private shipping companies (such as Fedex, UPS, DHL, and the like) and by governmentally operated customs organizations like the US Customs and Border Protection department of the US government.

In today's increasingly globally connected world, companies, such as Applied Materials rely on vendors around the world to provide manufacturing services on expensive parts that may be used in integrated circuit/chip manufacturing, for example. Such companies may rely on vendors to ship in-process parts to different companies in different US cities and states or that may reside in different countries, such as Japan for example. Delays in shipping and in processing through international customs offices can cause companies to suffer losses or to experience lack luster financial results because of delayed shipments of final products.

When a package is received at a customs office, its review—processing—and release from that customs office in a timely way can often be delayed even when private expeditors work with those customs offices for many of the same reasons that affect the US certified and registered mail processes.

Other issues that affect the shipment of international goods include contraband that is shipped across international borders. Contraband, such as opiates (natural or synthetic) synthetic cannabinoid like substances (spice) or other illicit drug are crossing borders including the border of the USA every day, while some reports indicate that such shipments are increasingly being sent from China to the USA through the US customs and US postal systems, such may be true from virtually any country.

What are needed are improved methods and systems for processing packages that are sent via public or private delivery and inspection systems. Especially when such improvements are directed to increasing shipping efficiencies, reducing service costs, improving asset tracking, or to increasing border security.

Various methodologies exist for the tracking of packages and deliveries. None of the existing methodologies, allow delivery organizations to take advantage of the presence of NFC readers in mobile devices and falling price of NFC tags. Nor do existing methods allow for automated workflow while maintaining the security, accuracy, and flexibility required by modern logistics and customer demands.

### SUMMARY OF THE PRESENTLY CLAIMED INVENTION

The presently claimed invention may utilize one or more near field communication (NFC) tags to track the movement of individual pieces of packages (eg: letters, mail, or boxes) as those packages move toward a destination. The presently claimed invention may be a method that may be implemented by apparatus or by a non-transitory computer readable medium of the present disclosure.

A method consistent with the present disclosure may receive information associated with a first NFC tag and shipping information via a network interface after which the information relating to that first NFC tag and shipping information may be stored in a database. This method may include receiving information from NFC scanners as a package associated with the NFC tag is moved toward a destination. After that information is received from the NFC scanners, the information stored in the database may be updated to include the information received from the NFC scanners. Next information may be received from a user device that is associated with a recipient of the package after that user device scans the first or the second NFC tag.

When the presently claimed invention is implemented as a non-transitory computer readable storage medium, a processor executing instructions out of a memory may implement steps of the present method. Here again the method may include receiving information associated with a first NFC tag and shipping information via a network interface after which the information relating to that first NFC tag and shipping information may be stored in a database. This method may include receiving information from NFC scanners as a package associated with the NFC tag is moved toward a destination. After that information is received from the NFC scanners, the information stored in the database may be updated to include the information received from the NFC scanners. Next information may be received from a user device that is associated with a recipient of the package after that user device scans the first or the second NFC tag.

An apparatus consistent with the present disclosure may include a network interface that receives information associated with a first NFC tag and shipping information. This apparatus may also include a database, a memory, and a processor that executes instructions out of the memory. The execution of the instructions by the processor may store the first NFC tag and shipping information in the database after which information from NFC scanners may be received via the network interface as a package associated with the NFC tag is moved toward a destination. The processor executing further instructions out of the memory may then update the information stored in the database to include the information received from the NFC scanners. Next information may be received from a user device that is associated with a recipient of the package after that user device scans a first or the second NFC tag.

### BRIEF DESCRIPTION OF THE DRAWINGS

FIG. 1 illustrates a near field communication (NFC) tracking system consistent with the present disclosure.

FIG. 2 illustrates a second exemplary NFC tracking system consistent with the present disclosure.

FIG. 3 illustrates a delivery label consistent with the present disclosure that includes at least two parts.

FIG. 4 illustrates an exemplary set of steps where delivery information is entered into a delivery system.

FIG. 5 illustrates an exemplary end-to-end work flow for tracking mail using NFC technology.

FIG. 6 illustrates an exemplary flow chart for tracking mail when it is in-transit using near field communication (NFC) technology.

FIG. 7A depicts the sender page of a delivery application that may be displayed in an exemplary graphical user interface (GUI) of a user device as a sender prepares to send a piece of mail.

FIG. 7B depicts two exemplary graphical user interfaces, one that may receive user signature information or settings and another that can be used to identify support selections.

FIG. 8 illustrates data that may be stored in a delivery database by systems consistent with the present disclosure.

FIG. 9 illustrates data that may be stored in a subject support database by an NFC tracking system.

FIG. 10 illustrates a computing system that may be used to implement an embodiment of the present invention.

### DETAILED DESCRIPTION

Methods and systems consistent with the present disclosure may reduce human error by increasing automation and by using wireless asset tracking devices in new ways. The use of near filed communication (NFC) chips and scanners to track individual pieces of mail as that mail moves through a delivery system from a sender to a receiver.

Methods and systems consistent with the present disclosure may utilize one or more NFC tags embedded in, affixed to, or printed into a delivery label. After an NFC shipping tag has been scanned, delivery information relating to shipping a piece of mail may be received and stored in a database, where that shipping information may be associated with the scanned NFC tag. When a shipping label includes two parts a first part may be a receipt portion (that includes a first NFC tag) that can be detached and retained by a sender of a piece of mail and may include a second portion that includes an NFC tag that stays attached to a piece of mail as it is delivered to a destination. A sender preparing to send mail may provide information that allows one or more electronic devices to receive messages as that NFC shipping label is scanned by different NFC scanners at different locations when that mail moves toward a destination.

Computer applications resident on or associated with a shipping entity may be used to receive information from packages as those packages move into, through, and out of a processing facility. Additionally the location of a package in a facility may be identified by using one or more NFC scanners. For example, a set of NFC scanners could scan individual zones of a shipping facility when identifying where particular packages are currently located.

Alternatively or additionally, a computer application resident on computing devices that belong to customers may be used to increase the accuracy of received shipping information. For example, an application program could store a shippers name and address, and that information could be sent to a delivery system electronically when a user devices scans an NFC shipping label or NFC shipping receipt. By electronically providing such information, the application at the user device prevents transcription errors that are common today when paper handwritten forms are filled in by customers.

Applications resident on such customer devices may also be sent information relating to the movement of a package as that package progresses through a delivery system. For example, a package shipped from Los Angeles Calif. to San Jose Calif. may be picked up at a shipper and pass through processing sites in Los Angeles and in San Jose before it is delivered to a destination address. As that package moves toward its destination, NFC scanners at each of these locations may send scanned data to a delivery system that stores location and time information in a database. At each step, messages may be sent to a sender's user device and to a user device of a recipient, for example.

Near field communication (NFC) devices, include NFC chips, radio frequency identifier (RFID) chips and NFC scanners/readers. NFC scanners can read data from passive or active RFID or NFC chips using radio signals that do not require direct line of sight to read. As such, NFC or RFID chips can be read without requiring NFC/RFID chips to be in the direct line-of-sight of an NFC reader.

Systems and methods consistent with the present disclosure may use either passive or active NFC/RFID chips in new ways. In certain instances, data stored in an active NFC tag, for example, may be updated to identify scanners that scanned it, dates/time, locations, or other information as that NFC tag moves through a shipping system. As such NFC/RFID chips themselves may be configured to record information that documents their movements to or toward a destination.

The use of NFC chips in managing mail (letters/packages) enables new forms of automated workflow management that increases the security, accuracy, and flexibility required by modern delivery and tracking systems. This technology allows delivery organizations to take advantage of the presence of NFC readers in mobile devices and the falling price of NFC tags. Furthermore NFC technology and can increase efficiency by tracking deliveries while maintaining a parallel chain of custody with a customizable list of relevant parties that can be provided updates in real-time as a package moves through its delivery lifecycle.

In certain instances a sender may create a list of relevant third parties who will also receive chain of custody notifications or records related to the delivery of mail. As such, both the sender and the receiver could be informed of a packages location as it moves through a delivery system. In cases of Certified Mail, third party providers may include services that can help the receiver solve Certified Mail issues regarding legal compliance, governmental oversight, or medical privacy concerns.

Methods and systems consistent with the present disclosure enables a receiver to communicate with a sender regarding the package that they have received. Such communications can be used to immediately inform senders of an issue regarding a delivery or to receive other feedback regarding their package. For example a receiver device may scan an NFC tag, identify a sender using that scanned information, and send a message directly to the sender. In such an instance, tracking information may provide a context for identifying the sender and the receiver device may access data stored in a delivery database of shipper when identifying the sender. As such, receivers can reach out and touch senders via “touch points,” such as a chat application, a text message, an audio message, a photo, a video, or combination thereof. Furthermore, such touch points may also allow receivers or senders to send messages to or received them from relevant third or governmental (e.g. U.S. customs) parties that may have been involved in the shipment of a package.

Another benefit that can be derived from the use of NFC technology in shipping is that it provides a unique opportunity for organizations, such as the USPS to monetize and self-fund the delivery of Certified Mail or Registered Mail.

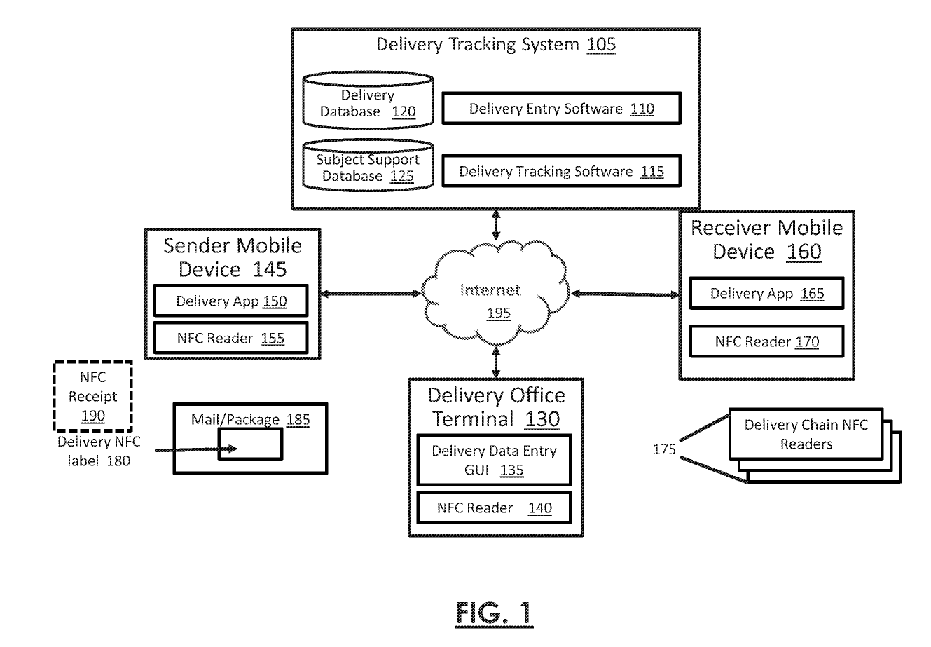

FIG. 1 illustrates a near field communication (NFC) tracking system consistent with the present disclosure. Methods and systems consistent with the present disclosure may replace traditional receipt/post card and bar code systems that may use a label/receipt having two associated and embedded, affixed, or printed NFC tags. The delivery chain may include a delivery tracking system 105, delivery office terminal 130, sender mobile device 145, and receiver mobile device 160, and a variety of NFC readers that makes use of a part NFC label/receipt that may include one or more parts or NFC chips. In certain instances deliver label 180 may include two parts and two NFC chips, where one of them may be detachable. In such instances NFC receipt 190 may be removed from package 185 when that package is shipped, where a NFC label 180 may stay affixed to package 185 during delivery.

The sender and receiver mobile devices 145/160 have NFC readers 155/170 respectively and upon scanning the NFC tag in either the receipt 190 or label 180, a delivery application 150 may be triggered/initiated at either sender mobile device 145 or at receiver mobile device 160. The delivery office terminal 105 may include a computer with an NFC reader and a delivery data entry interface 110 that allows a delivery office employee to enter data associated with the delivery. That data may be entered into a delivery database 120 that is a part of the delivery tracking system 105. The delivery tracking system also includes delivery entry software and delivery tracking software 115 that may be used to store and organize and cross reference shipment and transit data.

The delivery tracking system may further include a support database 125. This support database 125 may include a list of common subjects of delivery, such as legal, government, collection notices, and/or the names and URLs of organizations that offer support services related to a particular subject topic. The subject of the delivery may be defined or selected by the sender in delivery application 150. The delivery application 165 on a receiver mobile device may display a list of support options and/or radio/selection buttons that may link to a URL for organizations as defined by the sender. For example, a sender may send a legal document to a recipient, where delivery entry software 110 and delivery tracking software 115 at delivery tracking system 105 may update subject support database 125 with information regarding the delivery of that legal document. Furthermore, a user of receiver device may select a selection box displayed on a display at their mobile device to link to a legal entity (e.g. law firm or courthouse) via a URL associated with the legal document.

Delivery entry software 110 may be accessed by a delivery data entry interface on delivery office terminal 130. After a user logs into the system and enters data associated with a delivery such as recipient, sender name/address, signature requirements, and costs. Delivery office terminal 130 may be located within a post office, for example, where NFC reader 140 may be used to scan NFC receipt 190, such that a user would not always be required to access delivery tracking system 105 using their own personal device. The delivery data entry graphical user interface (GUI) 135 at delivery office terminal 130 may be used to prompt (ask/request) the user to scan the NFC tag on the detachable receipt portion 190 of the delivery label. That receipt tag 190 may then be associated with the “sender” in the delivery database 120. The user may then be prompted to scan the NFC tag in the delivery label 185 that includes a unique identifier associated with the ‘letter’ or deliverable in the delivery database. As such, receipt 190 may be distinguishable from delivery tag/label 180 that remains with the package 185.

The various devices discussed in FIG. 1 may communicate with each other via the Internet 195 or via a cellular phone network. As such sender mobile device 145 may communicate with delivery tracking system 105 using the Internet 195, a cellular network, or combination of cellular and the Internet 195.

The tracking process may begin when an NFC tag in a detachable receipt is scanned by a mobile device. Upon receipt of a scan of the unique identifier of the NFC tag in the detachable receipt 190, an identifier of the mobile device 145 may be entered into the delivery database 120 such that the mobile device 145 becomes or is associated with a specific “sender mobile device” 145. A sender page of the delivery application 150 as described herein may then be launched on sender mobile device 145. Through this delivery application 150, the sender can designate third parties who are to be notified of the chain of custody of the delivery of package 185 as it moves toward a destination. The sender can also designate the subject of the mail/package, such as a legal notice or collection notice. Updates are recorded in the delivery database 120. Once initially entered into the delivery database 120, the system proceeds to in-transit tracking of package 185.

In-transit through a delivery chain, NFC readers may poll or scan NFC tags and information in delivery database 120 may be updated as package 185 moves into, through, and out of a particular processing facility. When a tag is scanned, the location and time of the scan may be logged. The history of all scans for a given tag may be stored as a data file in delivery database 120. The mobile device associated with the sender 145 of one or more particular NFC tags 190/180 may be identified using the data stored in delivery database 120, where a notification of the location and time of the scan may be sent to electronic devices previously identified by the sender, such as sender mobile device 145 or receiver mobile device 160. Third-party devices associated with the tag may also receive notifications. Alternatively or additionally a sender may be allowed to customize the permissions of third parties so that they only receive specified notifications instead of all notifications. This process repeats with each scan of the NFC tag by a delivery chain NFC reader as package 185 moves toward its destination.

When the delivery tracking software receives a notification from the in-transit tracking module indicating that an NFC tag has been scanned by a mobile device, that mobile device may be identified as receiver mobile device 160 in delivery database 120 via delivery tracking software 115. Alternatively or additionally, receiver devices may be identified by the sender of a package when shipping information is initially provided by that sender. For example, a sender could identify a receiver device by identifying a phone number of the receiver's cell phone.

A signature page of the delivery application 165 may then be launched on the receiver mobile device 160. From this signature screen page, the receiver can sign with their finger, a stylus, or some other biometric indicator such as a fingerprint/face-scan/eye-scan. Messages or notes may also be composed by the receiver. When the receiver hits a “send” button, entered information may then be sent to the sender mobile device and designated third-parties via Internet 195 or another communication network. Some embodiments might involve a chat application, whereby, communications may be facilitated with audio, text, photos, or video. The present disclosure is not limited to the examples provided in the specification, as methods consistent with the present disclosure may receive any form of signature that may be required regarding a delivery. Furthermore, any other requirements associated with the delivery may be accounted for by delivery tracking system 105, such as contacting third parties of the delivery status, when required or desired.

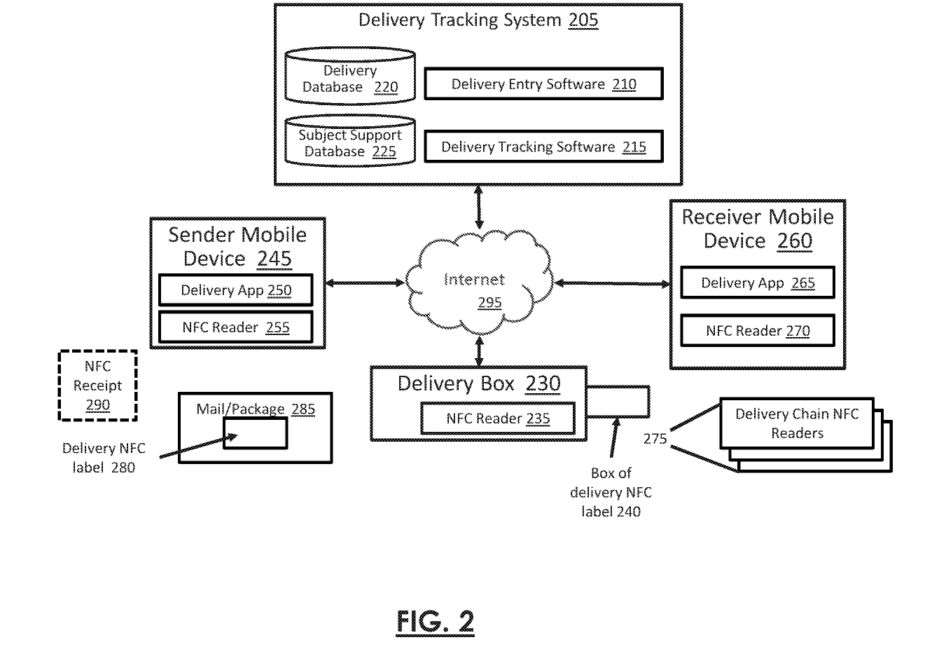

FIG. 2 illustrates a second exemplary NFC tracking system consistent with the present disclosure. FIG. 2 includes delivery tracking system 205, sender mobile device 245, receiver mobile device 260, delivery box 230, delivery NFC readers 275, mail package 285, and NFC tags 290 & 285.

Delivery tracking system 205 includes delivery entry software 210, delivery tracking software 215, delivery database 220, and subject support database 225 that may perform functions similar to corresponding elements included in the delivery tracking system 105 of FIG. 1.

Note that sender mobile device 245 of FIG. 2 includes delivery application 250 and NFC reader 255, that receiver mobile device 260 includes delivery application 265, and NFC reader 270. Here again sender mobile device 245 and receiver mobile device 260 may use methods similar to those discussed in respect to corresponding sender mobile device 145 and receiver mobile device 160 of FIG. 1. As such, sender mobile device 245 may be used to scan NFC receipt 290 when tracking mail package 285. Furthermore as delivery tracking system 205 tracks a package based on information received from sender mobile device, delivery chain NFC readers 275 scan delivery label 280 as a package as it is moved toward a destination where receiver mobile device 260 may scan NFC label 280 after the package has been delivered to its destination.

In the system of FIG. 2, a sender of a package may use delivery application 250 on a sender mobile device 245 to perform the functions of the delivery office terminal in the discussed in respect to FIG. 1 above. In such an instance the sender may enter relevant information into the delivery application 250 and then procure a delivery NFC label at a delivery box 230. Using the NFC reader 255 on the sender mobile device 245, the user may scan the delivery NFC label 280 or the NFC receipt 290. Data from this first scan may then be used to pair the unique identifier of the NFC tag in the delivery label 280 with the data entered by the sender in the delivery database 220. While the delivery NFC labels 280 of this particular embodiment may be stored in a container 240 affixed to the delivery box 230, alternatively they could be acquired by the sender in a variety of other means including ordering, picking up, or procurement at a distribution center. The NFC reader 235 of the delivery box 230 may be incorporated into the delivery chain otherwise disclosed above in respect to FIG. 1.

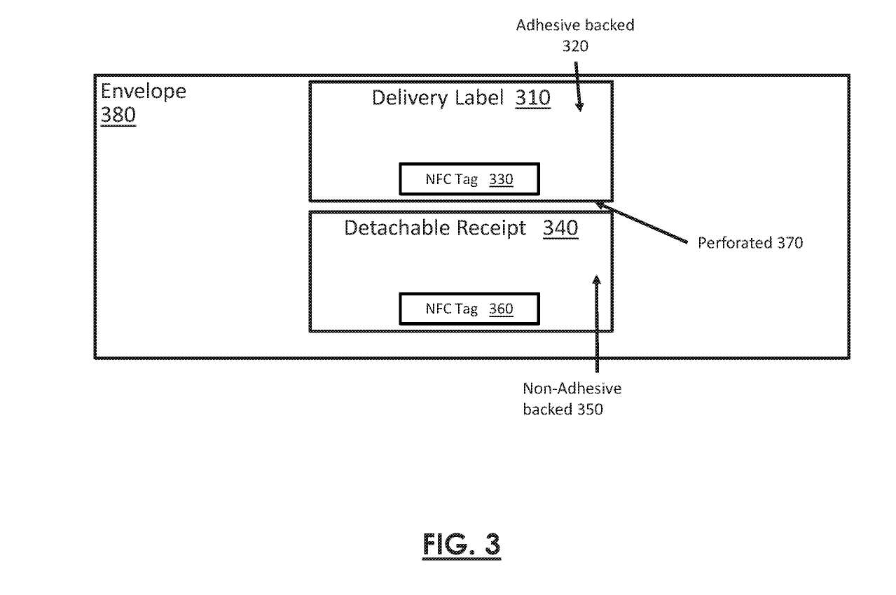

FIG. 3 illustrates a delivery label consistent with the present disclosure that includes at least two parts. The first part of the label is a delivery label 310 with an adhesive back 310B and a NFC tag 320 with a unique embedded identifier. The second part of the label is a detachable receipt 340 with no adhesive back 350 and that also includes an NFC tag 360 with a unique associated identifier. Additional parts of a shipping label tag set, beyond the first and second parts, may or may not contain additional NFC tags. The adhesive back on delivery label 310 allows delivery label 310 to be permanently affixed to envelope 380 while detachable receipt 340 may be removed from envelope 380 using perforations 370.

In other instances, only one NFC tag may be embedded in a delivery label. In such instances, the label may not include two parts. The delivery label of such an embodiment includes an adhesive back and a NFC tag with a unique embedded identifier. The delivery tracking software using such a label would identify a sender device not by scanning the NFC tag in the detachable receipt, but instead by being the first mobile device to scan the NFC tag in the delivery label. Subsequent scans of the tag by delivery chain NFC readers would update the delivery database as generally described above and in further detail herein. When the NFC tag is scanned by a second user mobile device, that device may be deemed to be the receiver.

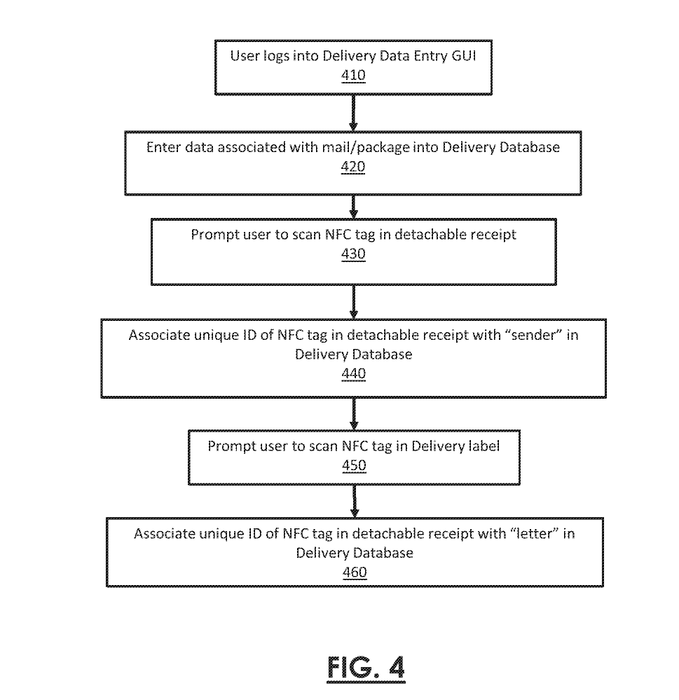

FIG. 4 illustrates an exemplary set of steps where delivery information is entered into a delivery system. In step 410 of FIG. 4 a user may login to a shipment system via a data entry graphical user interface (GUI) that may be presented on a display at a delivery office terminal or on a display of a user device. After the user logs into the system the user may then enter the data associated with the delivery of a piece of mail in step 420 of FIG. 4. This information might include recipe, that user may enter shipping data and sender name and address, signature requirements, recipient information (e.g. name, address, or phone number), and the user may approve costs associated with tracking their package.

Next in step 430 of FIG. 4, the user may be prompted to scan an NFC tag on a detachable receipt portion of a delivery label. This information may then be associated with the “sender” in a delivery database in step 440. The user may then be prompted to scan the NFC tag in the delivery label in step 450 of FIG. 4. That unique identifier is then associated with a “letter” or “package” in the delivery database in step 460 of FIG. 4.

Alternatively, a user may only be prompted to scan one of the two tags in a delivery label, where the NFC receipt and the NFC shipping label may include a same unique number and additional information. This additional information may be used to differentiate the NFC receipt from the NFC shipping label. In such instances a delivery tracking system consistent with the present disclosure could track packages through its delivery using the NFC shipping label when either the NFC receipt or the NFC shipping label were initially scanned in a step that associates these NFC tags with a package.

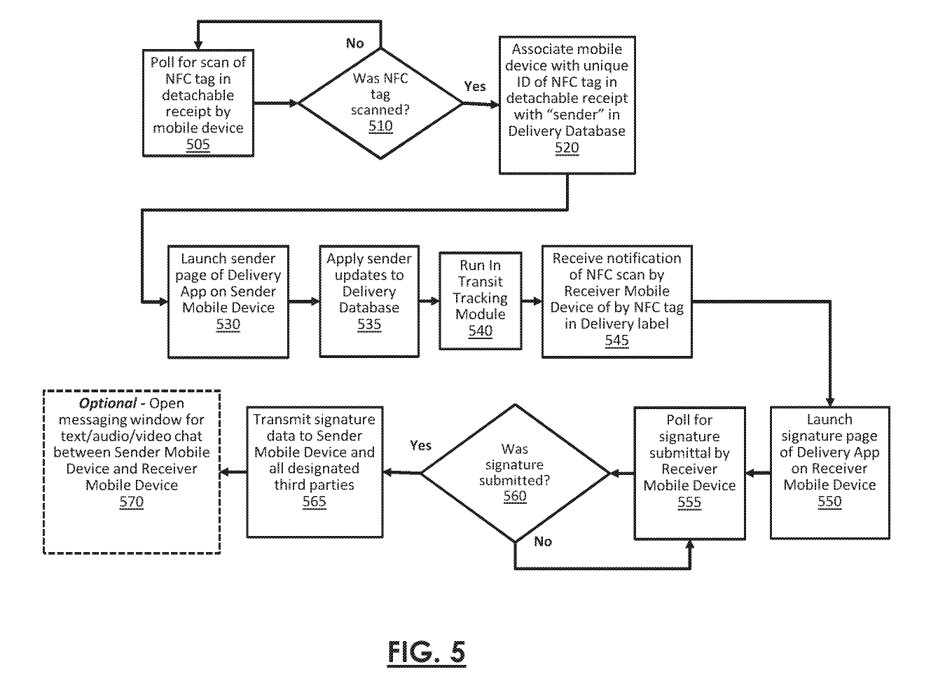

FIG. 5 illustrates an exemplary end-to-end work flow for tracking mail using NFC technology. The delivery tracking software of FIG. 5 begins in step 505 when an NFC tag in a detachable receipt is scanned by a mobile device. Optional step 510 may then identify that an NFC tag was scanned. When step 510 identifies that a tag was scanned, program flow may move to step 520 of FIG. 5. Program flow may move from step 510 to step 505 when determination step 510 attempted to poll for the presence of an NFC tag, yet did not receive a signal back from an NFC tag, for example.

Upon receipt of that scan, the unique identifier of the NFC tag in the detachable receipt may be associated with a mobile device identifier in the delivery database in step 520 of FIG. 5. The mobile device may then be associated with a “sender mobile device” in the database. The sender page of the delivery application may be launched on the sender mobile device in step 530 through which the sender can designate third parties who should be notified as to delivery status and chain of custody of a piece of mail. The sender can also designate the subject of the delivery. Updates may then be recorded in the delivery database in step 535, after which system then may then launch an in transit tracking module in step 540.

When the delivery tracking software receives the notification from the in transit tracking module that the NFC tag has been scanned by a mobile device in step 545, that mobile device may associated with a receiver in the delivery database. Next in step 550 a signature page of the delivery application may be launched on the receiver mobile device. This may be in the form of a graphical user interface (GUI). From this signature screen, the receiver can sign with their finger, a stylus, or provide other biometric information (fingerprint, face scan, or retinal scan) in step 555 of FIG. 5. Step 560 may then identify whether a signature has been provided by a receiver. When a signature has not been received, the flowchart of FIG. 5 proceeds back to step 555. Alternatively after a signature is received, flow may move from step 560 to step 565 where the signature data may be transmitted to a sender mobile device or to other devices that may have been previously identified by the sender. After step 565, optional step 570 may be performed that allows receivers and senders to communicate. Here again communications may be in the form of text messages, audio communications, or a video chat.

Messages may be composed via the GUI or via other means. In certain instances, the receiver may identify that information may be sent, which allows for entered information to be provisioned to the sender mobile device or to any designated third-party recipients. Chat programs may also be utilized to exchange information. Alternatively or additionally a recipient device could communicate information via text messages, audio, or video communications. Information provided by the receiver may include delivery information or status associated with the delivery. Receivers may also be able to identify that a package was damaged and information such as a photograph could be provided as part of an insurance claim.

Note that methods consistent with FIG. 5 may be implemented by a delivery tracking system that receives information from NFC scanners and that allows senders and receivers to communicate based on information stored in a database at a delivery tracking system. Methods and systems consistent with the present disclosure are not limited to requiring a particular device to perform a function relating to scanning an NFC tag by polling and then checking to see if NFC information has been received. Alternatively, methods and systems consistent with the present disclosure may scan an NFC tag and use information received from that NFC tag without requiring distinct steps of polling and determining whether NFC tag information has been received based on that polling.

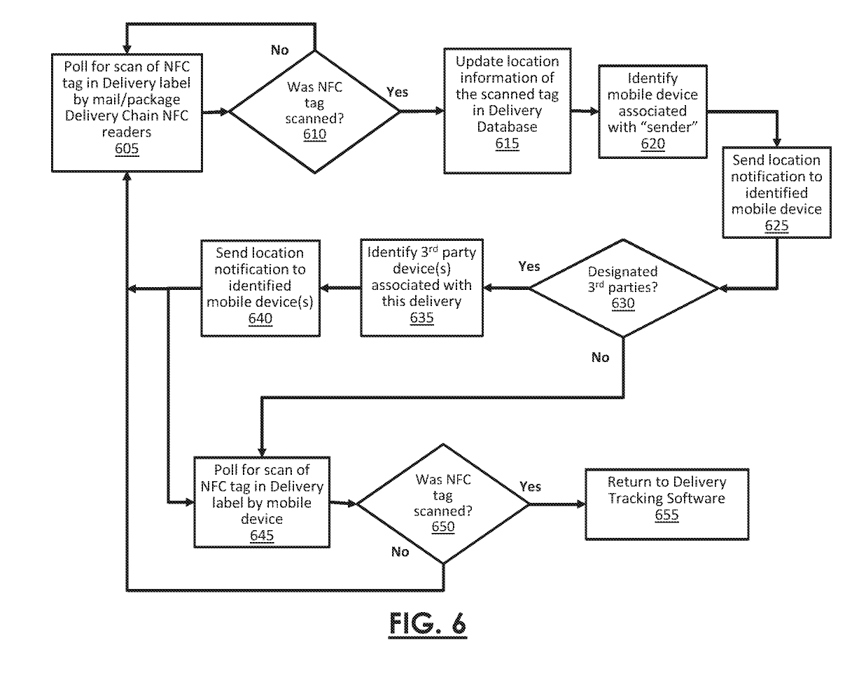

FIG. 6 illustrates an exemplary flow chart for tracking mail when it is in-transit using near field communication (NFC) technology. First in step 605 of FIG. 6 a NFC scanner polls to receive NFC tag information. Next determination step 610 identifies whether an NFC tag was scanned. When determination step 610 identified that a NFC tag has been scanned the flow chart of FIG. 6 proceeds to step 615, where location and time of the scan may be logged in a delivery database. The history of all scans for a given tag may be stored as a data file in the delivery database. When step 610 identifies that an NFC tag was not scanned in step 605, program flow may move back to step 605 where an NFC scanner may poll to see if there are any NFC tags that can be read.

The mobile device associated with the sender of this NFC tag may have be identified using information stored in the delivery database in step 620, after which a notification of the location and time of the scan may be sent to that sender mobile device or other devices in step 625 of FIG. 6. If there are any third-party devices associated with the tag in step 630 of FIG. 6, those third party vendors may be identified in step 635, and those third parties may then also be sent notifications regarding the location of the NFC label in step 640 of FIG. 6. Alternatively or additionally, the sender may customize the permissions of third parties so that they only receive certain specified notifications instead of all notifications. This process may repeat with each scan of the NFC tag by a delivery chain NFC reader. For example, as a package moves from one processing facility to another, program flow may move from step 640 to step 605 of FIG. 1.

Step 645 of FIG. 6 is a step where information is accessed to identify whether a receiver mobile device has polled for the presence of an NFC tag and step 650 may identify whether and NFC tag has been scanned, when no program flow moves back to step 605. Step 645 may be performed after 630 when no designated third parties have been designated to receive message regarding scanned NFC tags or step 645 may be performed after step 640 of FIG. 6. Alternatively when an NFC tag has been scanned by a receiver mobile device, program flow may move from step 650 to step 655 of FIG. 6 that identifies whether an NFC tag has been scanned by a receiver device, when no the flow chart of FIG. 6 may move back to step 605 where NFC readers associated with a shipping company may poll or scan NFC chips that are associated with pieces of mail. Alternatively, when step 650 of FIG. 6 identifies that a receiver mobile device has scanned an NFC tag a set of tasks associated with tracking or application software may be initiated, this tracking or application software may be used to inform the sender or any third parties of the receipt of the NFC tagged package by a receiver.

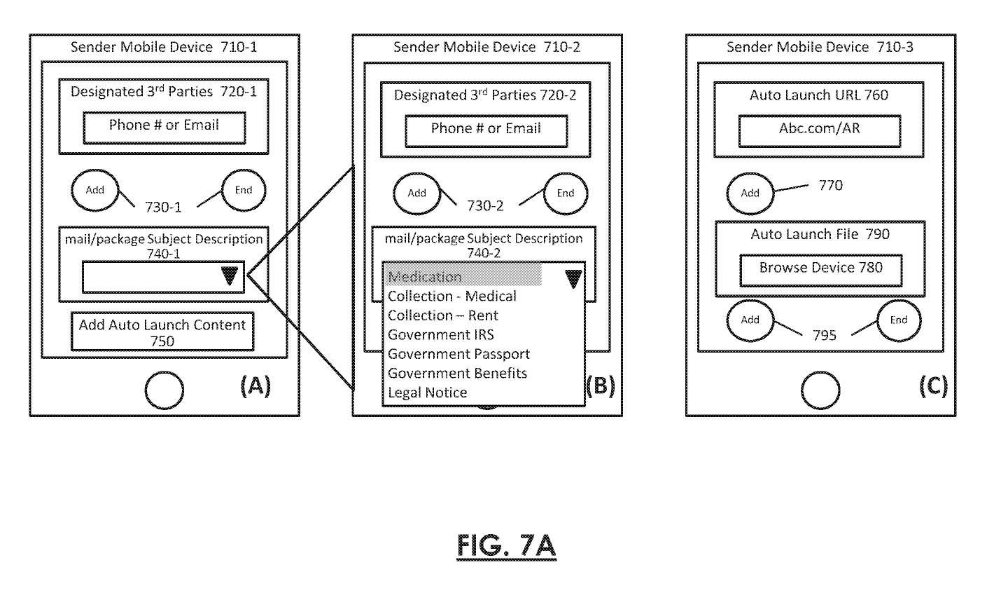

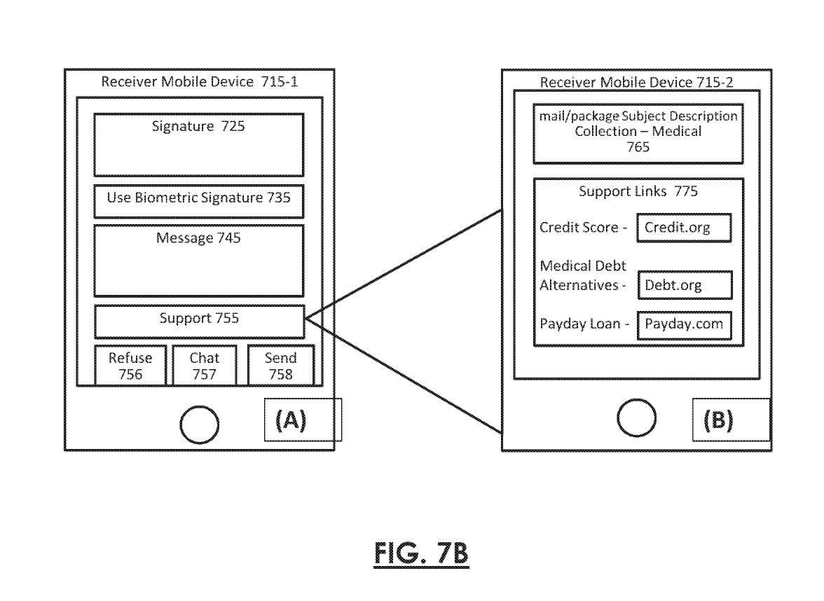

FIGS. 7A and 7B illustrate a series of delivery applications, specifically those for a sender and a signature, as may be used in the currently described NFC tracking system. FIG. 7A depicts the sender page of the delivery application that may be displayed in an exemplary graphical user interface (GUI) of a user device as a sender prepares to send a piece of mail. Sender mobile device GUI 710-1, item A of FIG. 7A includes a designated third parties data entry box 720-1, selection boxes add and end 730-1, mail/package description selection/data entry box 740-1, and an add auto launch content box, 750. The add & end selection boxes 730-1 may be used to add items to the GUI of sender mobile device 710-1 when the add selection box is selected or to close this GUI when end is selected.

The sender mobile device GUI 710-1 screen may appear after a sender scans an NFC tag in the detachable receipt portion of a delivery label. This GUI screen 710-1 may also appear in a single tag embodiment of the invention when the NFC tag in the delivery label is first scanned by a mobile device. Alternatively or additionally, the GUI screen 710-1 may be open when either a detachable tag or when a non-detachable tag has been scanned.

From the screen 710-1, the user of a sender mobile device may designate third-parties that should be sent notifications when a chain of custody event relating to the delivery an NFC tagged package is detected. Designated third parties may be identified in data entry selection box 720-1 using identifiers that may include a phone numbers or an email addresses. These third party identifiers may be stored in a database that tracks the delivery of a piece of mail.

Drop down menu data selection/entry box 740-1 allows for the sender to specify a subject of the delivery. When the drop down menu data selection/entry box 740-1 is selected in GUI 710-1, that GUI may be updated as illustrated in sender mobile device GUI 710-2 (item B of FIG. 7A), and a user may be the allowed to select a subject for the piece of mail. Note that the subject of ‘Medication’ is selected as indicated by the gray highlighting of GUI 710-2. Next if add selection box of selection boxes 730-2 is selected, the subject of ‘Medication’ may be linked to the particular NFC chip and to a piece of mail, where this linkage may be then be stored in a delivery database consistent with the present disclosure. Note that GUI 720-2 includes much of the same information as GUI 710-1 as it includes designated third parties data entry box 720-2, add/end selection boxes 730-2, and mail/package selection box 740-2.

At the bottom of the GUI 710-1 is a radio/selection button 750 that when selected may allow the user to add auto launch content. When add auto launch content selection button 750 is touched, the GUI 710-3 may be opened. GUI 710-3 includes auto-launch URL 760, add selection box 770, auto launch file selection box 790, and add/end section boxes 795.

Auto launch URL 760 or auto launch file 790 may be associated with types of media, as audio, video, text, photos, videos, or augmented and virtual reality that can be launched/initiated on the receiver mobile device when they scan the NFC tag upon receipt of the delivery, for example. As such, user mobile devices may be used to configure actions performed when a package reaches a destination and is scanned by a receiver user device.

The illustrated GUI 710-3, item C of FIG. 7A also shows a screen launched when the user selects the “Add Auto Launch Content” button 750. In the top box on such a screen, the sender can add the URL abc.com/AR that will auto launch when the receiver scans the NFC tag by selecting add button 770. The bottom box of GUI 710-3 allows the user to upload a file that will auto launch when the receiver scans the NFC tag. Either selection may be added to a column of the subject support database table. After the add selection box of selection boxes 795 is selected, a identified auto launch file selected using auto launch file section box 790 and a browse device selection box 780 may be added to a delivery database. When the end selection box of selection boxes 795 is selected, GUI 710-3 of FIG. 7A may be closes. Sender mobile devices, items A, B, and C may communicate with a delivery tracking system, then selected information may be added to a database at that delivery tracking system. Here again such communications may be performed via the Internet or via another form of communication network.

FIG. 7B depicts two exemplary graphical user interfaces, one that may receive user signature information or settings and another that can be used to identify support selections. GUI 715-1 (item A of FIG. 7B) may be displayed display on the receiver mobile device when the NFC tag in the portion of the delivery label adhered to the delivery is scanned. The top box is a free form box 725 that offers the receiver a space to sign with their finger or stylus. The second box is a radio button that that may launch a biometric lock on the receiver's mobile device, allowing them to sign for the mail/package with a biometric entry. The third box down is free form message box 745 that offers the receiver a space to compose a message to deliver to the sender along with their signature. A fourth selection box 755, is a radio button/selection box that may be used to setup support options specific to a subject of a delivery that may have previously been specified by the sender. Clicking on the support radio button/selection box 755 may launch GUI 715-2 that includes a mail subject description 765 and the support links 775. Support links 775 includes selection boxes of credit.org (where a credit score may be obtained), debt.org (where medical debt alternatives may be reviewed), and a payday.com selection box (where a payday loan may be accessed or requested). Information included in or selected in GUI 715-2 may be stored in a subject support database consistent with the present disclosure.

GUI 715-1 also includes selection boxes of refuse 756, chat 757, and 758 that can be used to refuse delivery of the item, launch a chat window with the sender mobile device, and to send a message to the sender mobile device. The chat window selection box can be associated with a text messaging system or with an audio/video communication program such as Skype.

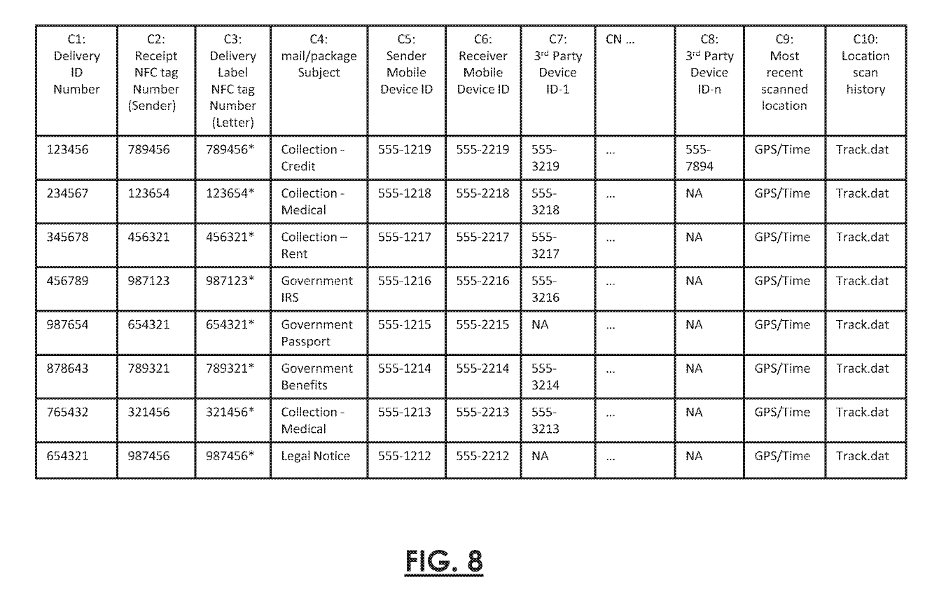

FIG. 8 illustrates data that may be stored in a delivery database by systems consistent with the present disclosure. The first column C1 of the database includes an identification number associated with a delivery. The second column C2 includes an NFC tag identifier from the detachable receipt associated with the delivery. The third column C3 includes an NFC tag identifier from the adhesive portion of the delivery label. The fourth column C4 contains the subject of the delivery as defined by the sender. The fifth column C5 contains the mobile device identifier associated with the sender by the delivery tracking software. The sixth column C6 of the database includes the mobile device identifier associated with the receiver by the delivery tracking software. The next series of columns C7, CN, & C8 show the device identifiers for various third-party devices designated by the sender. The final two columns C9 & C10 include the tracking data from all scans of the NFC tag in the adhesive portion of the delivery label by NFC readers in the delivery chain. The first of the two columns C1 & C2 reflects the most recent scan whereas the second of the two columns contains a data file with all of the scans in chronological order.

The database table of FIG. 8 also includes a plurality of different rows that can be used to cross reference cross reference a delivery identification number with a NFC receipt tag, a NFC delivery label tag number, a subject, a sender mobile device identifier, a receiver mobile device number, different third party contacts, a most recent scanned location that may be identified by a global positioning (GPS) location and a time, and other location tracking information (track.dat). Note that a first row of FIG. 8 cross references delivery ID number 123456 with NFC receipt tag 789456, NFC label 789456*, sender mobile device 555-1219, receiver ID 555-2219, and third parties 555-3219 & 555-7849. Based on settings set by a sender, each time a particular package is scanned by an NFC reader, messages may be sent to the sender device, the receiver device, and to third party computing devices. Furthermore databases consistent with the present disclosure may be used to store information that identifies each and every NFC reader that has scanned a particular NFC tag or store locations/times where a particular NFC tag was scanned.

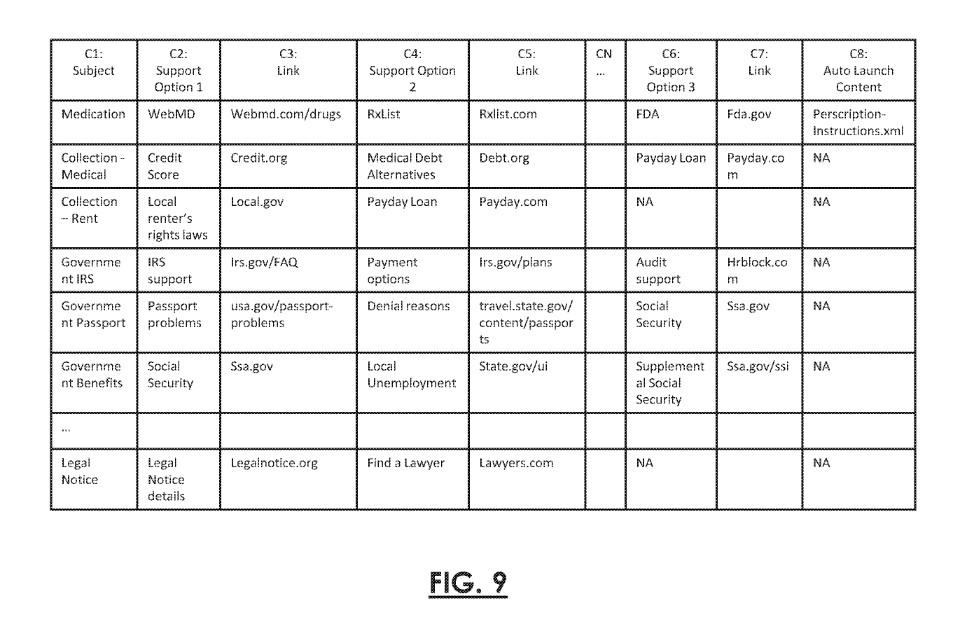

FIG. 9 illustrates data that may be stored in a subject support database by an NFC tracking system. This database contains links to subject specific support websites based on the common subjects of delivery. The first column C1 contains the subjects available from the drop down menu illustrated in the context of FIGS. 7A-7B. Subjects in column C1 include medication, collection-medication, collection-rent, government IRS, government benefits, and legal notice.

Each pair of following columns C2/C3, C4/C5, & C6/C7 include subject specific support outlet such as a name WebMD in column C2 and a URL webmd.com/drugs in column C3. The final column C8 of FIG. 9 reflects either the data file or URL for any auto launch content specified by the sender. Column CN indicates that additional columns may be added to the databased table of FIG. 9 when required or desired. As such, a first row in the database table of FIG. 9 cross references the subject of medication with WebMD with Webmd.com/drugs, RxList with Rxlist.com, FDA with Fda.gov, and with auto launch content of prescription-instructions.xml. Here again when a receiver device scans a NFC delivery label of the medication shipment, messages indicating that this package has been received by the receiver may be sent to the sender or to third parties and prescription-instructions may be provided to the receiver via their mobile device.

Systems and methods consistent with the present disclosure may be used by any organization that handles packages, including government organizations like U.S. customs. In certain instances organizations like U.S. customs may be allowed to access information relating to a chain of custody for a package. In such instances a sender may set a setting in a user interface that authorizes government customs organizations to access information stored in a delivery database and upon scanning an NFC delivery label, a governmental customs organization may be allowed to view information regarding the shipment of a package. Alternatively or additionally notifications may be sent to expediters or receivers after an NFC delivery tag is scanned by a customs organization. Such notifications may include information that may be used to help facilitate packages being quickly released by a customs organization. Such notifications may identify a precise location where a package is located so it can be easily found.

The information in the database table of FIG. 9 may be defined by operators of the delivery tracking system. This database could also include information from senders and receivers that could be used to expand/improve available offerings.

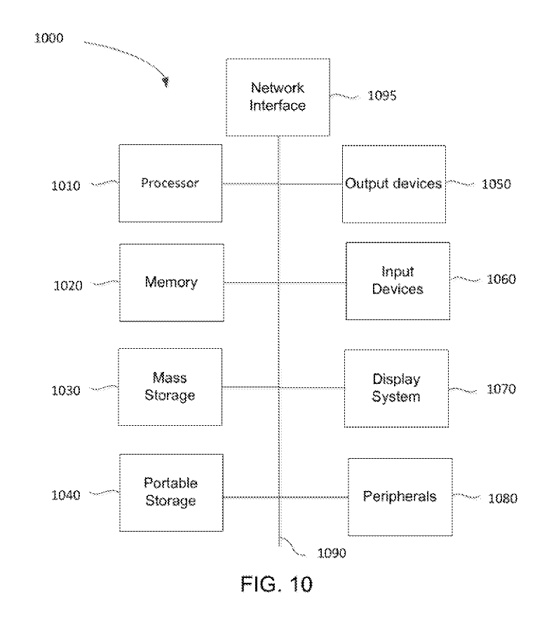

FIG. 10 illustrates a computing system that may be used to implement an embodiment of the present invention. The computing system 1000 of FIG. 10 includes one or more processors 1010 and main memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, peripheral devices 1080, and network interface 1095.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a FLASH memory, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD), a plasma display, an organic light-emitting diode (OLED) display, an electronic ink display, a projector-based display, a holographic display, or another suitable display device. Display system 1070 receives textual and graphical information, and processes the information for output to the display device. The display system 1070 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 1080 may include any type of computer support device to add additional functionality to the computer system. For example, peripheral device(s) 1080 may include a modem or a router.

Network interface 1095 may include any form of computer interface of a computer, whether that be a wired network or a wireless interface. As such, network interface 1095 may be an Ethernet network interface, a BlueTooth™ wireless interface, an 802.11 interface, or a cellular phone interface.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, FLASH memory, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for tracking packages, the method comprising:
receiving via a network interface information relating to a scanned first near field communication (NFC) tag;
receiving shipping information via the network interface regarding the shipment of a package to a recipient;
storing information in a database that cross-references the scanned first NFC tag with the shipping information;
receiving information from one or more NFC scanners as the package is moved toward the recipient based on the one or more NFC scanners scanning at least one of the first NFC tag or a second NFC tag that is associated with the first NFC tag;
updating the information stored in the database that cross-references the scanned NFC tag with the shipping information to include the information received from the one or more NFC scanners; and
receiving information from a user device that is associated with the recipient after the user device has scanned the at least one of the first NFC tag or the second NFC tag that is associated with the first NFC tag.

2. The method of claim 1, further comprising identifying that the recipient has received the package based on the information received from the user device.

3. The method of claim 2, further comprising:
sending a message to one or more electronic devices identified by the received shipping information after the information from one or more NFC scanners; and
sending a message to the one or more electronic devices identified by the received shipping information after identifying that the recipient has received the package.

4. The method of claim 1, wherein the shipping information identifies a user device that is associated with a sender of the package.

5. The method of claim 2, wherein the shipping information identifies one or more third party computing devices that should be sent messages after the information from the one or more NFC scanners is received and after identifying that the recipient has received the package.

6. The method of claim 1, wherein the shipping information identifies that a customs organization is authorized to access information regarding the package and the method further comprising:
receiving information from the customs organization after the customs organization has scanned the at least one of the first NFC tag or the second NFC tag that is associated with the first NFC tag; and
providing the information authorized according to the shipping information to the customs organization.

7. The method of claim 1, further comprising:
receiving information from a customs organization after the customs organization has scanned the at least one of the first NFC tag or the second NFC tag that is associated with the first NFC tag; and
sending a message to at least one of the sender or a third party that identifies that the customs organization has received the package.

8. The method of claim 1, wherein the shipping information identifies that a private shipping company is authorized to access information regarding the package and the method further comprising:
receiving information from the private shipping company after the private shipping company has scanned the at least one of the first NFC tag or the second NFC tag that is associated with the first NFC tag; and
providing the information authorized according to the shipping information to the private shipping company.

9. The method of claim 1, further comprising:
receiving information from a private shipping company after the private shipping company has scanned the at least one of the first NFC tag or the second NFC tag that is associated with the first NFC tag; and
sending a message to at least one of the sender or a third party that identifies that the private shipping company has received the package.

10. The method of claim 1, wherein an application at the recipient user device is initiated at the recipient user device has scanned the at least one of the first NFC tag or the second NFC tag that is associated with the first NFC tag.

11. The method of claim 1, further comprising receiving a signature from the recipient user device.

12. The method of claim 11, wherein the signature includes at least one of information entered via a graphical user interface by a finger or a stylus of the recipient or biometric information associated with the recipient.

13. A non-transitory computer-readable storage medium having embodied thereon a program executable by a processor for performing a method for tracking packages, the method comprising:
receiving via a network interface information relating to a scanned first near field communication (NFC) tag;
receiving shipping information regarding the shipment of a package to a recipient;
storing information in a database that cross-references the scanned first NFC tag with the shipping information;
receiving information from one or more NFC scanners as the package is moved toward the recipient based on the one or more NFC scanners scanning at least one of the first NFC tag or a second NFC tag that is associated with the first NFC tag;
updating the information stored in the database that cross-references the scanned NFC tag with the shipping information to include the information received from the one or more NFC scanners; and
receiving information from a user device that is associated with the recipient after the user device has scanned the at least one of the first NFC tag or the second NFC tag that is associated with the first NFC tag.

14. The non-transitory computer-readable storage medium of claim 13, further comprising identifying that the recipient has received the package based on the information received from the user device.

15. The non-transitory computer-readable storage medium of claim 14, the program further executable to:
send a message to one or more electronic devices identified by the received shipping information after the information from one or more NFC scanners; and
send a message the one or more electronic devices identified by the received shipping information after identifying that the recipient has received the package.

16. The non-transitory computer-readable storage medium of claim 13, wherein the shipping information identifies a user device that is associated with a sender of the package.

17. The non-transitory computer-readable storage medium of claim 14, wherein the shipping information identifies one or more third party computing devices that should be sent messages after the information from the one or more NFC scanners is received and after identifying that the recipient has received the package.

18. The non-transitory computer-readable storage medium of claim 13, wherein the shipping information identifies that a customs organization is authorized to access information regarding the package and the method further comprising:
receiving information from the customs organization after the customs organization has scanned the at least one of the first NFC tag or the second NFC tag that is associated with the first NFC tag; and
providing the information authorized according to the shipping information to the customs organization.

19. The non-transitory computer-readable storage medium of claim 13, the program further executable to:
receive information from a customs organization after the customs organization has scanned the at least one of the first NFC tag or the second NFC tag that is associated with the first NFC tag; and
send a message to at least one of the sender or a third party that identifies that the customs organization has received the package.

20. The non-transitory computer-readable storage medium of claim 13, wherein the shipping information identifies that a private shipping company is authorized to access information regarding the package and the method further comprising:
receiving information from the private shipping company after the private shipping company has scanned the at least one of the first NFC tag or the second NFC tag that is associated with the first NFC tag; and
providing the information authorized according to the shipping information to the private shipping company.

21. The non-transitory computer-readable storage medium of claim 13, the program further executable to:
receive information from a private shipping company after the private shipping company has scanned the at least one of the first NFC tag or the second NFC tag that is associated with the first NFC tag; and
send a message to at least one of the sender or a third party that identifies that the private shipping company has received the package.

22. The non-transitory computer-readable storage medium of claim 13, wherein an application at the recipient user device is initiated at the recipient user device has scanned the at least one of the first NFC tag or the second NFC tag that is associated with the first NFC tag.

23. The non-transitory computer-readable storage medium of claim 13, the program further executable to receive a signature from the recipient user device.

24. An apparatus for tracking packages, the apparatus comprising:
a network interface that:
receives information relating to a scanned first near field communication (NFC) tag,
receives information regarding the shipment of a package to a recipient;
a memory;
a processor that executes instructions out of the memory; and
a database, wherein:
the processor executing the instruction out of the memory stores information in the database, the stored information cross-referencing the scanned first NFC tag with the shipping information,
the network interface receives information from one or more NFC scanners as the package is moved toward the recipient based on the one or more NFC scanners scanning at least one of the first NFC tag or a second NFC tag that is associated with the first NFC tag,
the processor executing the instructions out of the memory updates the information stored in the database that cross-references the scanned NFC tag with the shipping information to include the information received from the one or more NFC scanners, and
the network interface receives information from a user device that is associated with the recipient after the user device has scanned the at least one of the first NFC tag or the second NFC tag that is associated with the first NFC tag.
